(19) United States
(12) Patent Application Publication
(10) Pub. No.: US 2013/0147620 A1
(43) Pub. Date: Jun. 13, 2013

(54) REMOTE MONITORING OF AN EMERGENCY SYSTEM DURING TEST OF EMERGENCY NOTIFICATION DEVICES

(71) Applicants: Donald Becker, Bradenton, FL (US); Morris Stoops, Bradenton, FL (US); Martin Camins, Waterloo (CA); Martin Paul Robotham, Bradenton, FL (US)

(72) Inventors: Donald Becker, Bradenton, FL (US); Morris Stoops, Bradenton, FL (US); Martin Camins, Waterloo (CA); Martin Paul Robotham, Bradenton, FL (US)

(73) Assignee: UTC FIRE & SECURITY AMERICAS CORPORATION, INC., Farmington, CT (US)

(21) Appl. No.: 13/323,488

(22) Filed: Dec. 12, 2011

(51) Int. Cl. G08B 29/00; G08B 1/08

(52) U.S. Cl. 340/514; 340/533; 340/538

(57) ABSTRACT

An emergency system includes a plurality of emergency notification devices, a control device, and a system controller. The control device is capable of wirelessly communicating with the plurality of emergency notification devices. The system controller is capable of communicating with the plurality of emergency notification devices over a wire pair. The control device is also capable of communicating with the system controller over a communication path that includes a wireless communication path between the control device and the notification device and a wired communication path between the notification device and the system controller.

### BACKGROUND

The present invention relates generally to the testing of emergency notification devices, and in particular to a system and method for monitoring an emergency system while testing emergency notification devices of the emergency system.

Notification devices for emergency systems are used to alert people of the occurrence of an emergency situation. For example, in the event of a fire in a building, strobe lights and sirens will be utilized to alert the occupants of the building so they may evacuate. Because of the importance of these systems, the devices, such as the strobe lights and sirens, must be tested on a regular basis in order to ensure proper functionality during an emergency.

These notification systems may include various zones of devices. A zone may be any grouping of devices, such as a floor of an office building. The devices in each zone communicate with a system control center. The system control center communicates with a monitoring station so that the station may deploy assistance to the location of the emergency. For example, if a fire is detected in the third floor of an office building, the third floor zone alerts the emergency control center, which in turn alerts the monitoring station so that fire fighters may be deployed to the building.

Testing of notification devices has traditionally been done on a system wide basis. The entire system is disconnected from the monitoring station so that no emergency vehicles are deployed due to the test. Because of this, a person would need to be stationed at the system control center to monitor for any real emergencies that occur during the test. If a real emergency is detected at the system control center, the test must be terminated, and the person stationed at the system control center would need to notify the monitoring station so that an emergency vehicle could be deployed.

This kind of testing is very obtrusive to any occupants of a building in which an emergency system is under test. Therefore, tests such as these are often done after hours which can bring with it various added costs.

### SUMMARY

A system and method includes a control device, a system controller, and one or more emergency notification devices. The control device communicates wirelessly with the emergency notification devices such that each emergency notification device may be tested apart from the emergency system as a whole. The control device receives indication of an emergency situation from the system controller by communicating with the system controller over a communication path. The communication path comprises a wireless path between the control device and the notification device, and a wired path between the notification device and the system controller.

### BRIEF DESCRIPTION OF THE DRAWINGS

FIG. 1 is a block diagram that illustrates an embodiment of the present invention.

FIG. 2 is a block diagram that illustrates a control device and an emergency notification device according to an embodiment of the present invention.

FIG. 3 is a flow chart that illustrates a method of testing the functionality of notification devices according to an embodiment of the present invention.

FIG. 4 is a flow chart that illustrates a method of testing the outputs of a notification device according to an embodiment of the present invention.

FIG. 5 is a flow chart that illustrates a method of manually monitoring an emergency system for emergency conditions according to an embodiment of the present invention.

### DETAILED DESCRIPTION

The present invention describes an emergency notification system that allows a system controller to indicate to one or more emergency notification devices that the system is operating in a test mode. While in the test mode, the outputs of the notification devices may be controlled in order to provide a less intrusive test of the system. A control device may also be used to wirelessly communicate with the notification devices. Using the control device, each notification device may be tested on an individual basis by a user of the control device. While testing any portion of the emergency system, the user may monitor the rest of the emergency system by communicating with the system controller. The user may be any person, but will typically be an installer of an emergency notification system, or an emergency notification system technician.

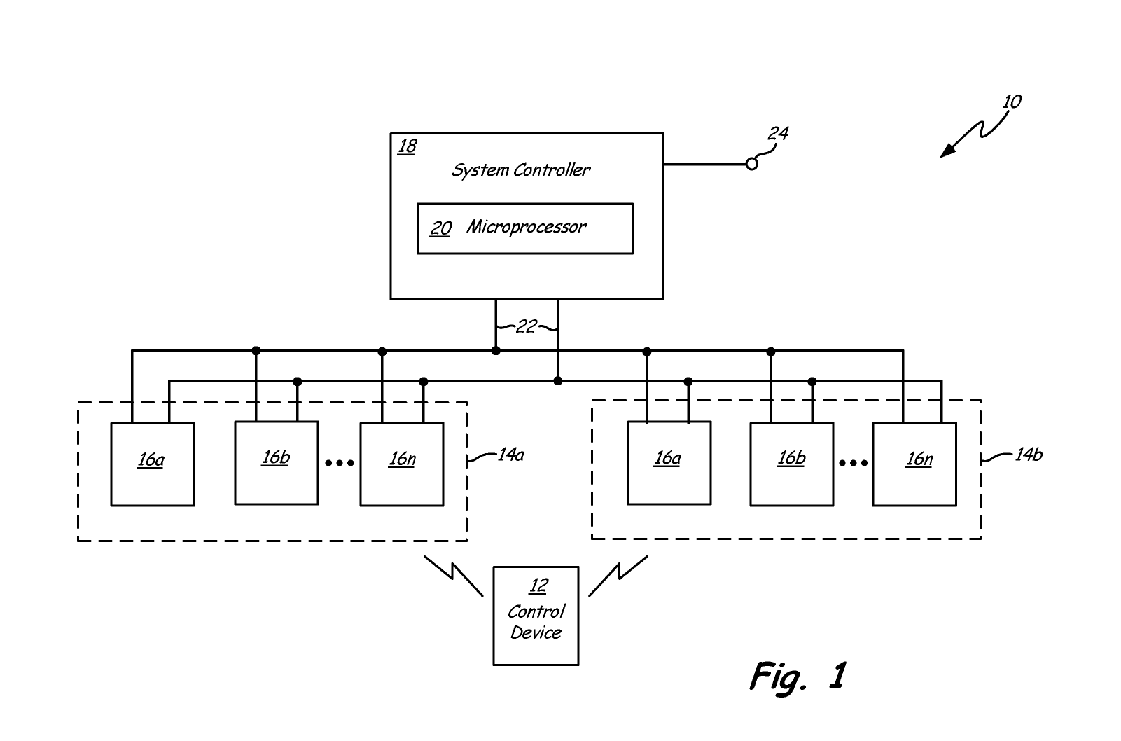

FIG. 1 is a block diagram illustrating an embodiment of emergency system 10. In this embodiment, system 10 includes control device 12, groups 14a-14b, emergency notification devices 16a-16n, system controller 18, and wire pair 22. System controller 18 contains microprocessor 20, and monitoring station output 24. Monitoring station output 24 is used to alert a monitoring station of a detected emergency so that the monitoring station may deploy help, for example, by deploying fire trucks. Control device 12 is configured to communicate wirelessly with notification devices 16a-16n.

Emergency system 10 contains two groups 14a-14b, but may contain any number of groups. Each group contains a plurality of notification devices 16a-16n. Each notification device 16a-16n is connected to system controller 18 by wire pair 22. System controller 18 provides power to, and communicates with the plurality of emergency notification devices 16a-16n over wire pair 22. Each notification device 16a-16n is individually addressable such that it may communicate bi-directionally with system controller 18 over wire pair 22.

During an emergency, notification devices 16a-16n provide notification to an area affected by an emergency condition. For example, if emergency notification devices 16a-16n have an output speaker, the output speaker may be used as a siren to alert persons in the area of a fire. Input devices, such as smoke detectors, detect smoke from the fire and alert system controller 18. In turn, microprocessor 20 of system controller 18 generates commands and sends the commands to notification devices 16a-16n over wire pair 22. Notification devices 16a-16n receive the commands and use their respective outputs to alert persons in the area of the fire. System controller 18 also notifies a remote monitoring station using monitoring station output 24 of a detected emergency condition so that, for example, fire trucks may be deployed to the area of emergency system 10.

Emergency notification devices 16a-16n need to be tested on a regular basis to ensure proper functionality during an emergency condition. An installer or technician initiates a test at system controller 18. System controller 18 transitions into a test mode and disables monitoring station output 24. System controller 18 can send commands to notification devices 16a-16n to indicate that emergency system 10 is operating in the test mode. The test may comprise, for example, triggering various input devices to simulate an emergency condition, and monitoring notification devices 16a-16n to ensure that they operate in response to the simulated emergency condition.

During a test of the functionality of emergency notification devices 16a-16n, system controller 18 may send commands to each of notification devices 16a-16n to adjust output settings of the respective notification devices. For example, the output of a siren may be decreased to 68 decibels as opposed to an emergency operating output of 85 decibels. Therefore, functionality of system 10 may be tested without creating as much of a disturbance to persons occupying the area of system 10. Additionally, the expectation during design, development and validation of emergency notification devices 16a-16n is that more than 95% of the device utilization will be for testing purposes and that less than 5% will be for actual emergency use. By reducing the device output load during a test, the device service longevity and reliability will be positively impacted.

Devices may also be tested on an individual or group-wide basis when emergency system 10 is operating in a test mode. Control device 12 may be used to activate a single notification device, or a group of notification devices, in order to test the respective output peripherals of the notification devices. Control device 12 wirelessly communicates commands to selected notification devices 16a-16n in order to enable the output peripherals of the respective notification devices. The output peripherals of the respective notification devices may then be measured to ensure proper functionality. For example, a siren may be tested to determine if it is capable of producing a required 85 decibels during an emergency condition. By conducting this testing on a device by device basis, the disturbance placed on persons in the area of emergency system 10 during the test is reduced.

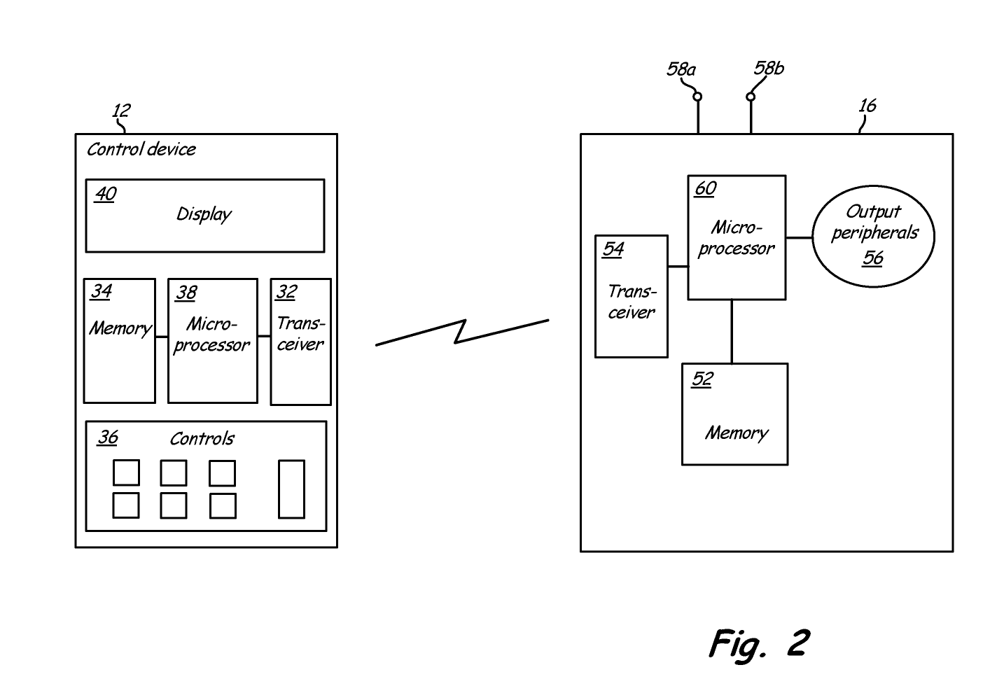

Embodiments of control device 12 and notification device 16 (representative of devices 16a-16n) are depicted in FIG. 2. Notification device 16 includes memory 52, wireless radio frequency transceiver 54, output peripherals 56, system control inputs 58a-58b, and microprocessor 60. Memory 52 is configured to store an address of notification device 16, identifiers regarding groups of devices of which notification device 16 is a member, and an emergency system identifier. The system identifier indicates the emergency system 10 of which notification device 16 is a member. Output peripherals 56 may be speakers, LEDs, or any other type of output devices. System control terminals 58a-58b receive power, commands, audio signals, and other information from wire pair 22.

Control device 12 includes wireless radio frequency transceiver 32, memory 34, controls 36, microprocessor 38, and display 40. Transceiver 32 is configured to communicate bi-directionally with transceiver 54 of notification device 16. Wireless communication may be accomplished using the Radio Frequency for Consumer Electronics (RF4CE) and IEEE 802.15.4 wireless protocol standards, or any other wireless protocol standards capable of providing bi-directional communication between control device 12 and notification device 16. Controls 36 may be any type of input user interface, such as a keyboard, or a touch screen.

Control device 12 must have authorization to communicate with notification device 16. Control device 12 may contain a database in its memory 34 that contains information pertaining to notification devices 16a-16n with which it may communicate. This database includes emergency system identifiers, addresses of notification devices 16a-16n, identifiers regarding groups 14a-14b, and any other information necessary to communicate with notification devices 16a-16n, such as validation keys and encryption keys. This database may be loaded into memory 34 of control device 12, for example, using software provided by manufacturers of system 10. When initiating communication between control device 12 and notification device 16, notification device 16 will verify that control device 12 has permission to communicate with notification device 16 by comparing the identifiers stored in memory 34 with identifiers stored in memory 52.

Control device 12 is also able to communicate with system controller 18 through notification device 16. Control device 12 sends queries and commands intended for system controller 18 to notification device 16. Notification device 16 receives this communication, and sends the communication to system controller 18 on wire pair 22. System controller 18 receives the communication and may respond to control device 12. When responding, system controller 18 sends communication back to notification device 16 over wire pair 22, and notification device 16 sends the communication to control device 12.

Control device 12 is able to monitor for an emergency condition elsewhere in system 10 while communicating with notification device 16. Because control device 12 may communicate with system controller 18 through notification device 16, control device 12 may query system controller 18 for a status update of emergency system 10. System controller 18 may respond by sending an indication to notification device 16 when an emergency condition has been reported to system controller 18 from an input device of emergency system 10. This indication is received on terminals 58a-58b, handled by microprocessor 60, and forwarded to control device 12 through transceiver 54. Control device 12 receives the notification through transceiver 32, and microprocessor 38 sends the indication to display 40. A user of control device 12 may then take appropriate action, such as alerting a monitoring station of the emergency condition. This eliminates the need to have a person stationed at system controller 18 during a test.

Control device 12 may test notification device 16 individually when emergency system 10 is in a test mode. Control device 12 sends notification device 16 commands indicating that notification device 16 should enable its output peripherals 56. A user of control device 12 may then measure the outputs of output peripherals 56 to determine if the outputs are operating at a proper capacity for an emergency condition.

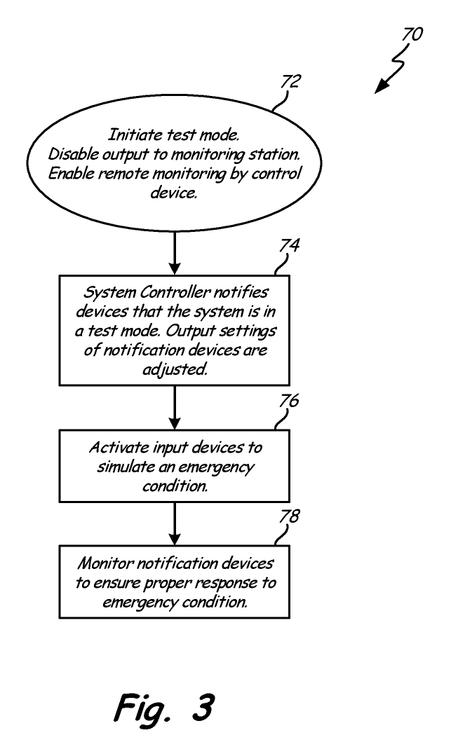

FIG. 3 is a flow chart illustrating a method 70 for testing the functionality of emergency notification devices according to an embodiment of the present invention. At step 72, system controller 18 is transitioned into a test mode and the connection between system controller 18 and any monitoring station is disabled. Remote monitoring of emergency system 10 using control device 12 is enabled. At step 74, system controller 18 notifies all notification devices 16a-16n that the system is operating in a test mode. System controller 18 also sends commands to notification devices 16a-16n in order to decrease the output intensity of each of the output peripherals of the respective notification devices. At step 76, input devices are activated to simulate an emergency condition. At step 78, notification devices 16a-16n are monitored to verify that they each provided a correct response to the emergency condition.

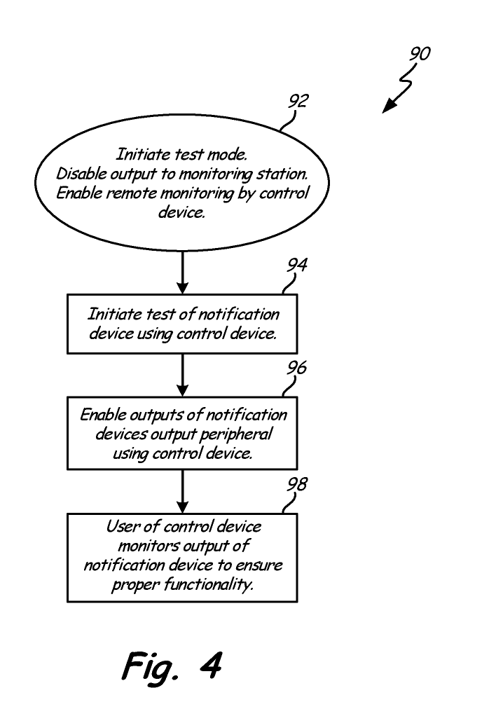

FIG. 4 is a flow chart illustrating a method 90 for testing the output capacity of notification device 16. At step 92, system controller 18 is transitioned into a test mode and the connection between system controller 18 and any monitoring station is disabled. Remote monitoring of emergency system 10 using control device 12 is enabled. At step 94, control device 12 initiates communication with notification device 16. At step 96, control device 12 sends commands to notification device 16, such that output peripherals 56 provide emergency outputs. At step 98, a user of control device 12 monitors the emergency outputs of output peripherals 56 to ensure proper functionality.

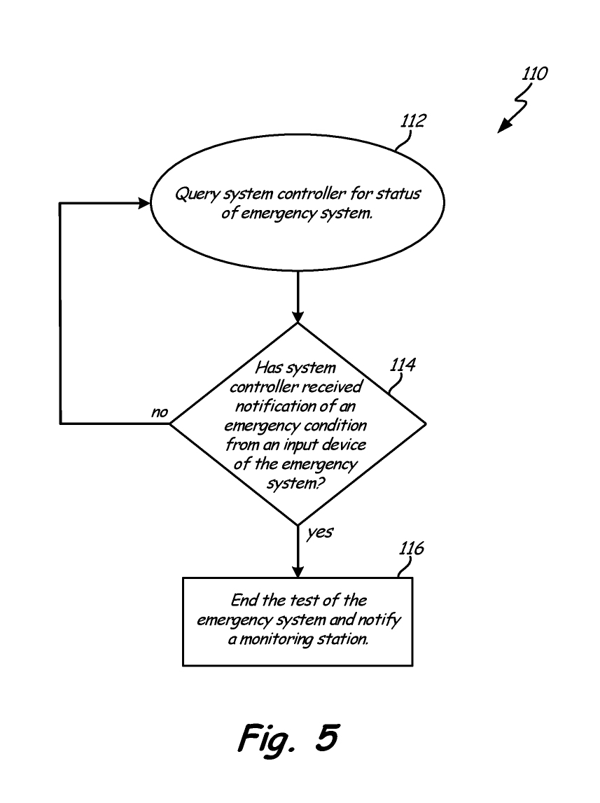

FIG. 5 is a flow chart illustrating a method 110 for using control device 12 to remotely monitor emergency system 10 for an emergency condition during a test of emergency system 10. At step 112, control device 12 queries system controller 18 for the status of emergency system 10. At step 114, if system controller 18 has received notification of an emergency condition from an input device of emergency system 10, method 110 proceeds to step 116. If system controller 18 has not received notification of an emergency condition from an input device of emergency 10, method 110 proceeds to step 112. At step 116, a user of control device 12 ends the test of emergency system 10 and notifies a monitoring station.

In this way, the present invention provides a system and method for remotely testing emergency notification devices. Although the present invention has been described with reference to preferred embodiments, it will be understood by those skilled in the art that various changes may be made and equivalents may be substituted for elements thereof without departing from the scope of the invention.

1. An emergency system comprising:
a plurality of emergency notification devices;
a control device capable of wirelessly communicating with the plurality of emergency notification devices;
a system controller capable of communicating with the plurality of emergency notification devices over a wire pair; and
wherein the control device is capable of communicating with the system controller over a communication path, wherein the communication path comprises a wireless communication path between the control device and one of the plurality of emergency notification devices, and a wired communication path between the one of the plurality of emergency notification devices and the system controller.

2. The system of claim 1, wherein the system controller adjusts output settings of output peripherals of each of the plurality of emergency notification devices when the emergency system is operating in a test mode by communicating commands to each of the plurality of emergency notification devices over the wire pair.

3. The system of claim 1, wherein the control device initiates a test of one of the plurality of notification devices when the system is in a test mode by wirelessly sending commands to the one of the plurality of notification devices, and wherein the test comprises activation of outputs of output peripherals of the one of the plurality of notification devices.

4. The system of claim 1, wherein the wire pair provides power to the plurality of emergency notification devices.

5. A method for testing a plurality of emergency notification devices of an emergency system, the method comprising:
transitioning a system controller from a normal operating mode to a test mode;
initiating a test of one or more emergency notification devices, each emergency notification device capable of communicating with the system controller over a wire pair, and wherein the test comprises simulating an emergency condition and monitoring the one or more emergency notification devices' response to the simulated emergency condition; and
monitoring the emergency system for a real emergency condition using a control device during the test of the one or more emergency notification devices, wherein the control device wirelessly communicates with the one or more emergency notification devices during the test.

6. The method of claim 5, wherein monitoring the emergency system using the control device comprises the control device communicating with the system controller over a communication path, wherein the communication path comprises a wireless communication path between the control device and one of the one or more emergency notification devices, and a wired communication path between the one of the one or more emergency notification devices and the system controller.

7. The method of claim 5, wherein the wire pair provides power to the one or more emergency notification devices.

8. The method of claim 5, wherein initiating a test of one or more emergency notification devices further comprises the system controller communicating commands to the one or more emergency notification devices to adjust output settings of output peripherals of each of the one or more notification devices.

9. The method of claim 5, wherein transitioning a system controller from a normal operating mode to a test mode includes disabling an output from the system controller to a monitoring station.

10. The method of claim 9, wherein the method further comprises:
upon completion of the test of the one or more emergency notification devices, transitioning the system controller from the test mode to the normal operating mode and re-enabling the output from the system controller to the monitoring station.

11. A method for testing emergency outputs of an emergency notification device, the method comprising:
transitioning a system controller from a normal operating mode to a test mode;
initiating a test of the emergency notification device using a control device, wherein the control device wirelessly communicates with the emergency notification device, and wherein the test comprises enabling the emergency outputs of output peripherals of the emergency notification device and monitoring the emergency outputs; and
monitoring the emergency system for a real emergency condition using the control device during the test of the emergency notification device.

12. The method of claim 11, wherein the system controller is capable of communicating with the emergency notification device over a wire pair.

13. The method of claim 12, wherein monitoring the emergency system using the control device comprises the control device communicating with the system controller over a communication path, wherein the communication path comprises a wireless communication path between the control device and the emergency notification device, and a wired communication path between the emergency notification device and the system controller.

14. The method of claim 11, wherein the control device communicates wirelessly with the emergency notification device using a radio frequency transceiver.

15. The method of claim 11, the method further comprising:
upon completion of the test of the emergency notification device, transitioning the system controller from the test mode to the normal operating mode.
